(19) United States
(12) Patent Application Publication
(10) Pub. No.: US 2026/0169697 A1
(43) Pub. Date: Jun. 18, 2026

(54) RANDOM NUMBER GENERATION

(71) Applicant: STMicroelectronics International N.V., Geneva (CH)

(72) Inventors: David ROUBINET, Trets (FR); Jimmy FORT, Puyloubier (FR); Thierry SOUDE, Puyloubier (FR); Remy ROUBINET, Le Cheylard (FR)

(73) Assignee: STMicroelectronics International N.V., Geneva (CH)

(21) Appl. No.: 19/415,375

(22) Filed: Dec. 10, 2025

(30) Foreign Application Priority Data
Dec. 13, 2024 (FR) FR2414102

(51) Int. Cl. G06F 7/58

(52) U.S. Cl. CPC G06F 7/588

(57) ABSTRACT

A random number generation method uses a discrete chaotic system. An implementation of the discrete chaotic system uses a first function made up of an integer number n of second affine functions which, for an input value in the range from zero to one, zero and one inclusive, provide an output value in the range from zero to one, zero and one inclusive.

### PRIORITY CLAIM

This application claims the priority benefit of French Application for Patent No. FR2414102, filed on Dec. 13, 2024, the content of which is hereby incorporated by reference in its entirety to the maximum extent allowable by law.

### TECHNICAL FIELD

The present disclosure generally concerns electronic systems and devices and, more specifically, random number generation within these electronic systems and devices.

### BACKGROUND

Random number generators are devices configured to produce sequences of numbers for which there is no deterministic link between a number and its predecessor(s).

Random number generators are used in all sorts of fields, but particularly in the field of computer security. Random numbers are typically used for data encryption, for example for the generation of encryption and/or decryption keys, or for the implementation of authentication methods.

Random number generation can be performed based, for example, on physical phenomena, on analog signal processing, and/or on digital signal processing.

It would be desirable to be able to improve, at least partly, certain aspects of random number generators and of associated random number generation methods.

There is a need for more efficient and more reliable random number generation.

There is a need for such random number generation methods.

There is a need for such random number generators.

There is a need to overcome all or part of the disadvantages of known random number generations.

### SUMMARY

An embodiment provides a random number generation method or system using a discrete chaotic system.

An embodiment provides a random number generation method or system using a discrete chaotic system based on the use of affine functions.

An embodiment provides a random number generation method configured to use a discrete chaotic system having an implementation with a first function made up of an integer number n of second affine functions which, for an input value in the range from zero to one, zero and one inclusive, provide an output value in the range from zero to one, zero and one inclusive.

Another embodiment provides a random number generator comprising a circuit implementing a discrete chaotic system that uses for its implementation a first function made up of an integer number n of second affine functions which, for an input value in the range from zero to one, zero and one inclusive, provide an output value in the range from zero to one, zero and one inclusive.

According to an embodiment, said discrete chaotic system further uses a comparison of a value with at least one threshold.

According to an embodiment, integer n is even.

According to an embodiment, integer n is a power of two.

According to an embodiment, integer n is equal to 2 or 4.

According to an embodiment, said second affine functions all have a negative slope.

According to an embodiment, said second affine functions all have a positive slope.

According to an embodiment, a first part of said second affine functions have a negative slope and a second part of said affine functions have a positive slope.

According to an embodiment, said discrete chaotic system is implemented by an electronic circuit in which said input and output values are current values.

According to an embodiment, said discrete chaotic system is implemented by an electronic circuit in which said input and output values are voltage values.

According to an embodiment, said input value is comprised in a first set included in a second set being the set of real values in the range from zero to one, this first set being reduced by from 10 to 30% of the values with respect to the second set, said second value being comprised in this first set.

Another embodiment provides an authentication method using a previously-described method.

Another embodiment provides an electronic device comprising a previously-described random number generator.

Another embodiment provides an electronic device configured to implement the previously-described method.

### BRIEF DESCRIPTION OF THE DRAWINGS

The foregoing features and advantages, as well as others, will be described in detail in the rest of the disclosure of specific embodiments given as an illustration and not limitation with reference to the accompanying drawings, in which:

FIG. 1 shows an embodiment of an electronic device;

FIG. 2 shows an embodiment of a random number generator;

FIG. 3 shows curves illustrating discrete chaotic systems;

FIG. 4 shows graphs (A), (B) and (C) illustrating discrete chaotic systems implemented over different numbers of iterations;

FIG. 5 shows a curve illustrating an example of a first discrete chaotic system;

FIG. 6 shows a block diagram illustrating the operation of the discrete chaotic system of FIG. 5;

FIG. 7 shows an electrical diagram of an electronic circuit configured to implement the discrete chaotic system of FIG. 5;

FIG. 8 shows a curve illustrating an example of a second discrete chaotic system; and

FIG. 9 shows an electrical diagram of an electronic circuit configured to implement the discrete chaotic system of FIG. 8.

### DETAILED DESCRIPTION

Like features have been designated by like references in the various figures. In particular, the structural and/or functional features that are common among the various embodiments may have the same references and may dispose identical structural, dimensional and material properties.

For the sake of clarity, only those steps and elements that are useful for understanding the described embodiments have been shown and are described in detail. Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following description, where reference is made to absolute position qualifiers, such as the terms “front”, “back”, “top”, “bottom”, “left”, “right”, etc., or relative position qualifiers, such as the terms “top”, “bottom”, “upper”, “lower”, etc., or orientation qualifiers, such as “horizontal”, “vertical”, etc., reference is made unless otherwise specified to the orientation of the drawings.

Unless specified otherwise, the expressions “about”, “approximately”, “substantially”, and “in the order of” signify plus or minus 10%, preferably of plus or minus 5%.

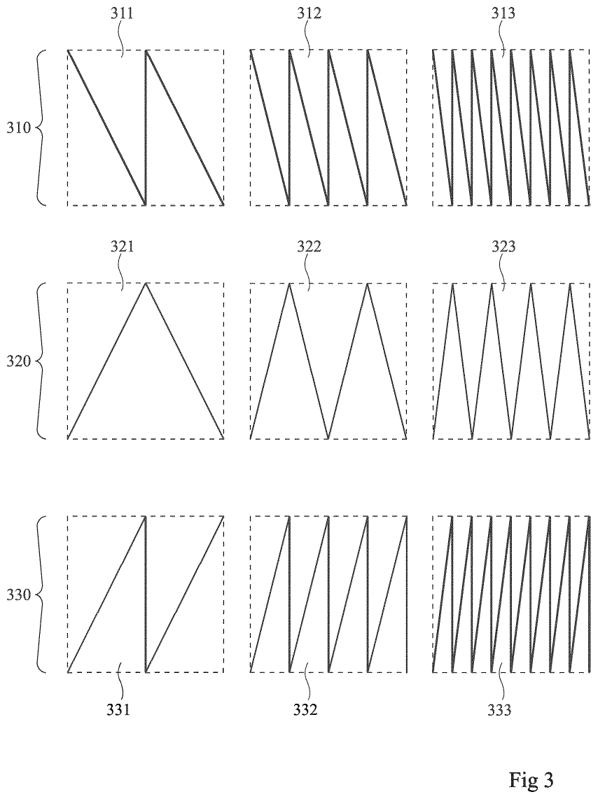

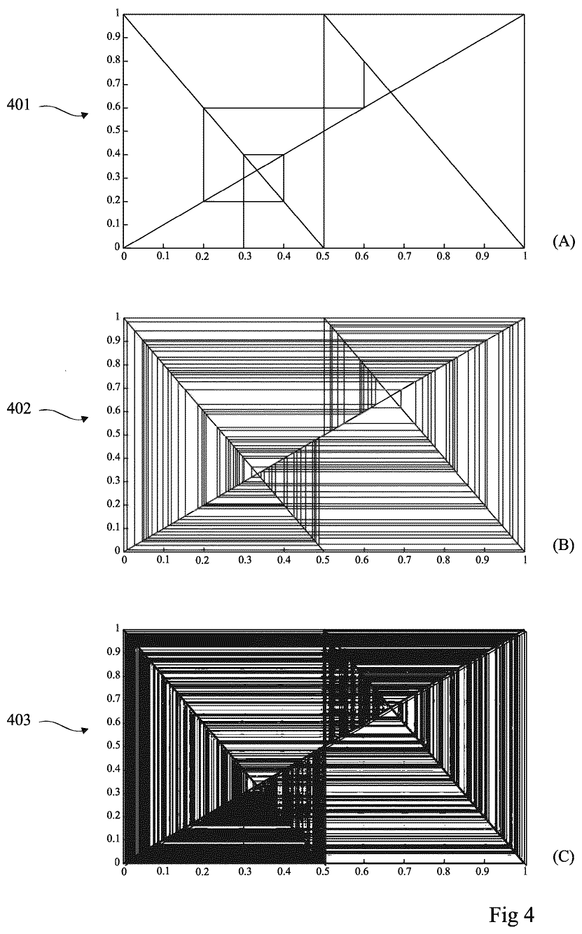

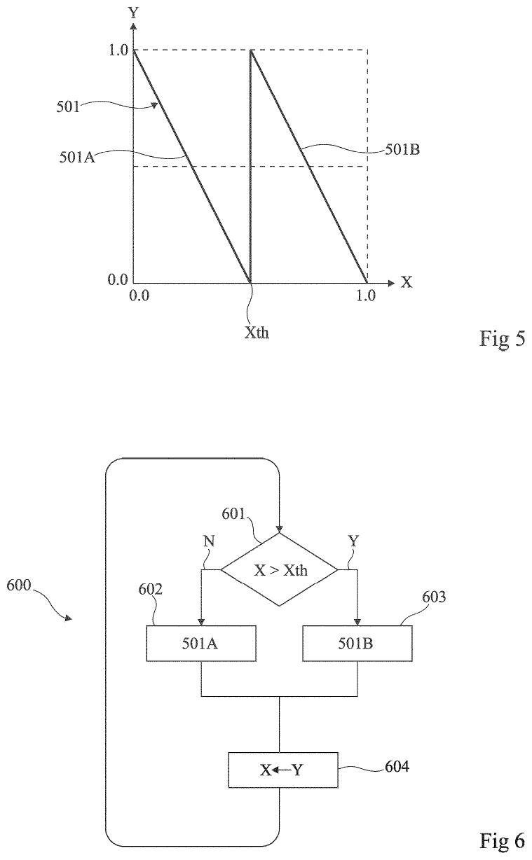

The embodiments described hereafter concern random number generation, that is, a random number generation method and a random number generation device, or random number generator. More particularly, the embodiments described hereafter provide using a discrete chaotic system to generate random numbers. A dynamic system is said to be chaotic if it is sensitive to one or more initial conditions, and if it exhibits a recurrence phenomenon. A chaotic system is said to be discrete when its recurrence phenomenon is artificially driven by a discrete notion of time. Discrete chaotic systems have previously been used, for example, to simulate demographic behaviors, but embodiments herein utilize the discrete chaotic systems for random number generation. Different types of discrete random systems are described in relation with FIGS. 3 and 4. Two examples of practical implementations of such systems are described in detail in relation with FIGS. 5 to 9.

Further, the embodiments described hereafter are particularly configured to be used in applications in the field of IT security, for example for the encryption of data, such as secret data, and for example for the implementation of authentication methods.

Further, the above-described embodiments are particularly configured to be used in any type of industrial market using random number generators. More particularly, such a random number generator may be intended for: the automotive industry, for example in the field of automotive electrification or in the field of advanced driver assistance systems (ADAS); the industrial sector, for example in the field of green energy, in the field of infrastructure electrification, of the Internet of Things (IoT) and of smart homes, where electricity and energy consumption and data exchange are key elements; the personal electronics industry, for example in the field of mobile telephony and of the Internet of Things (IoT), as well as in high-speed interfaces; the industry of communications equipment, computers and peripherals, for example in the field of infrastructures and data centers, and in the field of low earth orbit (LEO) satellites; and the industry of security, such as the security of transactions, particularly banking transactions, and the fight against counterfeiting.

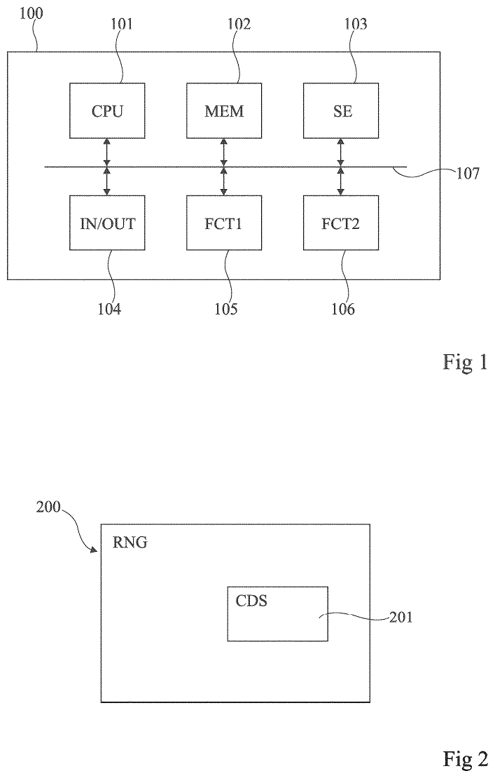

FIG. 1 is a block diagram very schematically showing an architecture of an example of an electronic device 100 configured to implement a random number generation.

Electronic device 100 comprises, for example, a processor 101 (CPU) configured to implement various data processing operations on data stored in memories and/or delivered by other circuits of device 100. According to an embodiment, processor 101 may be configured to generate random numbers.

According to an example, electronic device 100 further comprises different types of memories 102 (MEM), including, for example, a non-volatile memory, a volatile memory, and/or a read-only memory. Each memory 102 is configured to store different types of data.

According to an example, electronic device 100 further comprises, for example, a secure element 103 (SE) configured to process sensitive and/or secret data. Secure element 103 may comprise its own processor(s), its own memory or memories, etc. According to an embodiment, secure element 101 may be configured to generate random numbers or may comprise a circuit configured to generate random numbers.

According to an example, electronic device 100 may further comprise interface circuits 104 (IN/OUT) configured to send and/or receive data from outside device 100. Interface circuits 104 may be further configured to implement a data display, for example, a display screen.

According to an example, electronic device 100 further comprises various circuits 105 (FCT1) and 106 (FCT2) configured to perform different functions. As an example, circuits 105 and 106 may comprise measurement circuits, data conversion circuits, etc. According to an embodiment, circuits 105 and 106 may comprise a circuit configured to generate random numbers.

According to an example, electronic device 100 further comprises one or more data buses 107 configured to transfer data between its various components.

More precisely, electronic device 100 is configured to implement at least one computer program product comprising program code instructions recorded on a support usable in a computer, comprising computer-readable programming means for implementing a method of random number generation according to an embodiment.

According to an example, electronic device 100 may be configured to process sensitive data, such as secret data, and may, for this purpose, implement one or more encryption algorithms. The random number generation implemented by device 100 may be used in the execution of this or these encryption algorithm(s).

According to another example, electronic device 100 may be configured to implement one or more authentication methods, for example to identify itself to other electronic devices or, for example, to identify some of these internal components to one another. Device 100 may, for this purpose, use random numbers.

FIG. 2 shows, very schematically and in the form of blocks, an embodiment of a random number generation circuit 200, or random number generator 200 (RNG).

According to an embodiment, generator 200 is a discrete electronic circuit configured to be used in an electronic device of the type of the device 100 described in relation with FIG. 1. According to a variant, generator 200 is a computer program configured to implement a random number generation method which is executed on a processing circuit such as the CPU.

According to an embodiment, generator 200 comprises a circuit 201 (CDS) configured to implement a discrete chaotic system. According to an embodiment, circuit 201 is a discrete electronic circuit. According to a variant, circuit 201 is a computer program configured to implement a discrete chaotic system which is executed on a processing circuit such as the CPU.

Generator 200 is configured to output a series of data bits having randomly-distributed values, zero or one. The inventors have found that it is possible, for this purpose, to use the mathematical model of a discrete chaotic system. Indeed, a discrete chaotic system consists of the successive application of one or more mathematical functions. For this purpose, an initial value is supplied to the system, the function is applied for a first time, after which the function is applied iteratively to the previously-obtained result over a number of iterations, for example more than 100 to 1,000 iterations. After an initialization phase in which the distribution of the values obtained is not random, known as the Lyapunov horizon, the distribution becomes random. Examples of the mathematical functions used are described in detail hereafter.

FIG. 3 comprises graphs illustrating different types of mathematical functions that can be used to implement a discrete chaotic system.

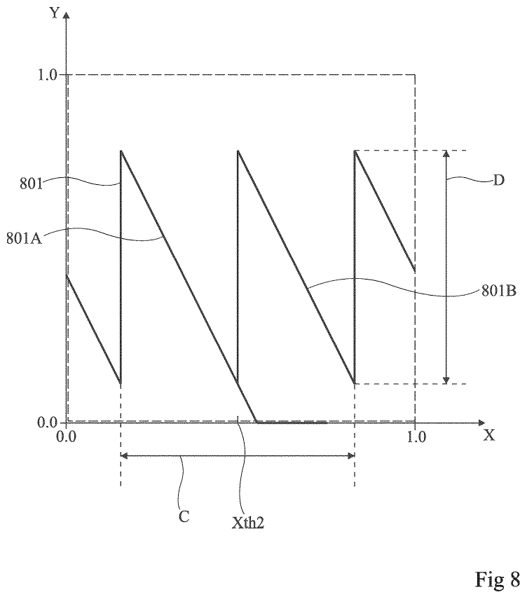

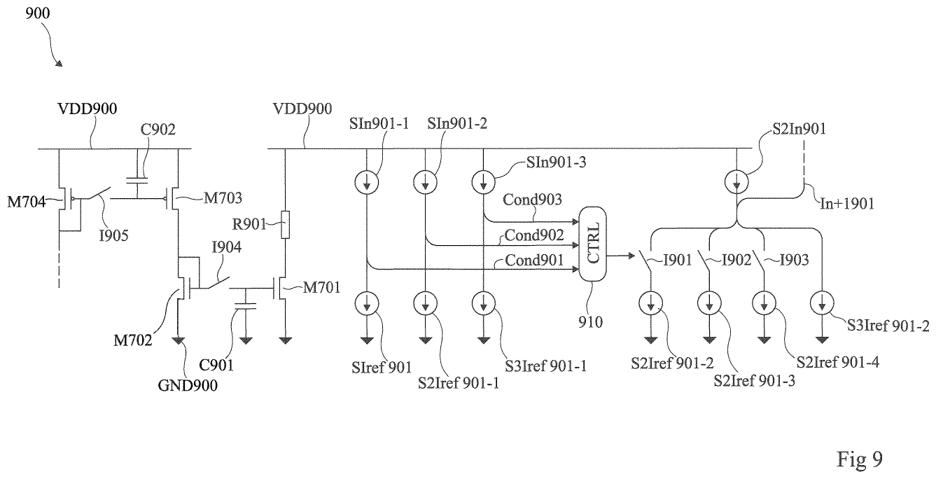

According to an embodiment, the mathematical functions considered herein are mathematical functions having a domain, or set of departure, equal to its set of destination. According to a first embodiment, the domain of this function is the set of real numbers in the range from zero to one, zero and one being included in this set. According to a second embodiment, the domain of this function is a set included in the set of real numbers in the range from zero to one, this first set being reduced by 10 to 30% of the values. This second embodiment is described in greater detail in relation with FIGS. 8 and 9.

According to an embodiment, the mathematical functions considered herein are functions formed of the assembly of a plurality of affine functions. More particularly, the domain is divided into a plurality of intervals, and a different affine function is used over each interval. According to an embodiment, the mathematical functions considered herein are formed of a number n of affine functions, n being an integer. According to an embodiment, n is an even integer, preferably a power of two. According to a preferred embodiment, n is equal to two or four.

A first type of function 310 uses only affine functions having negative slopes. This first type of function 310 is the type of function preferred for the implementation of the embodiments concerned herein. For a function 311, the domain is divided into two intervals, and two affine functions are used. For a function 312, the domain is divided into four intervals, and four affine functions are used. For a function 313, the domain is divided into eight intervals, and eight affine functions are used.

A second type of function 320 uses affine functions having positive and negative slopes. For a function 321, the domain is divided into two intervals, and two affine functions are used (one with a positive slope and the other with a negative slope). For a function 322, the domain is divided into four intervals, and four affine functions are used (two with positive slopes and two others with negative slopes). For a function 323, the domain is divided into eight intervals, and eight affine functions are used (four with positive slopes and four others with negative slopes).

A third type of function 330 uses only affine functions having positive slopes. For a function 331, the domain is divided into two intervals, and two affine functions are used. For a function 332, the domain is divided into four intervals, and four affine functions are used. For a function 333, the domain is divided into eight intervals, and eight affine functions are used.

FIG. 4 comprises three views (A), (B), and (C), each showing a graph illustrating the implementation of a discrete chaotic system using a function of the type of the function 311 described in relation with FIG. 3.

Each of these views illustrates the distribution of the values obtained at each iteration of a discrete chaotic system.

View (A) shows, in a graph 401, the implementation of this discrete chaotic system after four rounds, or four iterations, have been performed.

View (B) shows, in a graph 401, the implementation of this discrete chaotic system after a hundred iterations have been performed.

View (C) shows, in a graph 401, the implementation of this discrete chaotic system after a thousand iterations have been performed.

FIGS. 5 and 6 illustrate a more specific example of a function of the type of the function 311 described in relation with FIG. 3 used for the implementation of a discrete chaotic system for random number generation.

FIG. 5 is a curve illustrating a function 501 of the type of the function 311 described in relation with FIG. 3.

According to an embodiment, function 501 is configured to be used to implement a discrete chaotic system.

According to an embodiment, the domain of function 501 is the set of real numbers in the range from zero to one, and the set of destination of function 501 is the set of real numbers in the range from zero to one, zero and one being included in this domain.

Function 501 is obtained by assembly of two affine functions 501A and 501B having negative slopes. According to an embodiment, the domain of function 501A is the set of real numbers in the range from zero to a real number Xth, zero and Xth being included, and the domain of function 501B is the set of real numbers in the range from real number Xth to one, Xth and one being included in this set. Real number Xth is called the threshold value of function 501.

According to a specific example, real number Xth is equal to 0.5. In this case, the mathematical expression of affine function 501A is the following:

$$501 A : y ( x ) = 1 - 2 * x$$

Similarly, the mathematical expression of affine function 501B is the following:

$$501 B : y ( x ) = 2 - 2 * x$$

FIG. 6 is a block diagram illustrating the implementation of the function 501 described in relation with FIG. 5 for the execution of a discrete chaotic system.

At a step 601 (X>Xth), the input piece of data to which function 501 is applied is compared with real number Xth. According to an example, during the implementation of a discrete chaotic system, the input piece of data is either an initialization piece of data if the current iteration is the first iteration, or the output piece of data of the previous iteration. If this piece of data is smaller than real number Xth (Output Y), the next step is a step 602 (501A), otherwise the next step is a step 603 (501B).

At step 602, affine function 501A is applied to the input piece of data.

At step 603, affine function 501B is applied to the input piece of data.

In the case of the implementation of a discrete chaotic system, a step 604 (X←Y), successive to step 602 and step 603, is implemented. At this step 604, the piece of data obtained at step 602 or 603 is stored to be used in a subsequent iteration.

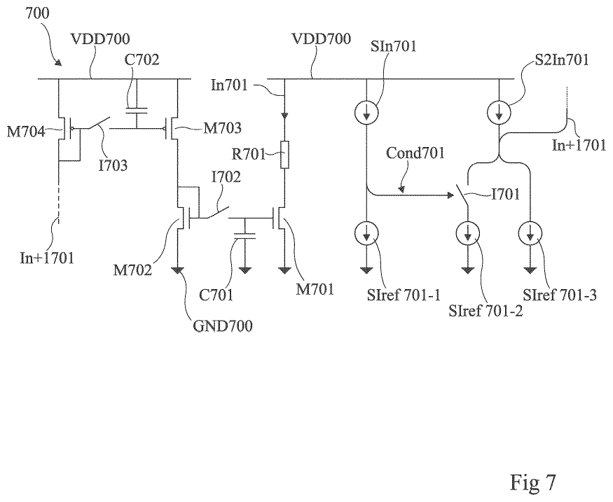

FIG. 7 is an example of an electronic circuit 700 configured to implement the function 501 described in relation with FIG. 1.

According to an example, electronic circuit 700 is a current implementation of function 501. In other words, the input and output values of function 501 are current values. It would within the abilities of those skilled in the art to devise a voltage implementation of function 501, that is, an implementation of function 501 where the input and output values are voltage or potential values.

According to an example, circuit 700 comprises two first current sources configured to deliver a multiple of a current In701. It is considered that the value of this current In701 represents, at the turning-on of circuit 700, the initial value imposed on function 501. Then, during the rest of the operation of circuit 700, that is, during the implementation of the various iterations of the discrete chaotic system using function 501, current value In701 corresponds to the image value obtained at the output of function 501. In practice, circuit 700 comprises a current source SIn701 configured to supply current In701, a current source S2In701 configured to supply twice current In701. According to an example, sources SIn701 and S2In701 are powered with a power supply potential VDD700.

According to an example, circuit 700 further comprises three second current sources SIref701-1, SIref701-2, and SIref701-3, all configured to supply a reference current Iref701. The value of reference current Iref701 represents the threshold value Xth of function 501. According to an example, current source SIref701-1 is configured to be powered by current source SIn701, and is coupled, preferably connected, to a node delivering a reference potential GND701. The junction node of current sources Sin701 and SIref701-1 enables to implement a condition Cond701, executing the step 601 described in relation with FIG. 6. According to an example, current source SIref701-2 is configured to be supplied by current source S2In701 via a switch I701, and is coupled, preferably connected, to a node delivering a reference potential GND701. According to an example, switch I701 is controlled by condition Cond701, that is, by the potential delivered by the junction node of current sources Sin701 and SIref701-1. According to an example, current source SIref701-3 is configured to be supplied by current source S2In701, and is coupled, preferably connected, to a node delivering a reference potential GND701.

According to an example, circuit 700 further comprises a resistor R701 and a first current mirror circuit. According to an example, a first terminal of resistor R701 receives power supply potential VDD700, and a second terminal of the resistor R701 is coupled, preferably connected, to an output terminal of the first current mirror circuit.

According to an example, this first current mirror is formed by using metal-oxide-semiconductor field-effect transistors, or MOSFET transistors, or MOS transistors. Further, this first current mirror uses N-channel MOS transistors, or N-type MOS transistors, or NMOS transistors. More particularly, the first current mirror comprises two transistors M701 and M702. A first conduction terminal of transistor M701, forming an output terminal of the first current mirror, is coupled, preferably connected, to the second terminal of resistor R701, and a second conduction terminal of transistor M701 is coupled, preferably connected, to the node delivering reference potential GND700. A first conduction terminal of transistor M702, forming an input terminal of the first current mirror, is coupled, preferably connected, to the control terminal of transistor M702, and a second conduction terminal of transistor M702 is coupled, preferably connected, to the node delivering reference potential GND700.

According to an example, circuit 700 further comprises a switch I702 and a capacitor C701 arranged within the first current mirror. More particularly, a first conduction terminal of switch I702 is coupled, preferably connected, to the conduction terminal of transistor M701, and a second conduction terminal of the switch I702 is coupled, preferably connected, to the conduction terminal of transistor M702. A control terminal of switch I702 (not shown in FIG. 7) is configured to receive a clock signal clocking the operation of circuit 700. A first terminal of capacitor C701 is coupled, preferably connected, to the control terminal of transistor M701, and a second terminal of capacitor C701 is coupled, preferably connected, to the node receiving reference potential GND700.

According to an example, circuit 700 further comprises a second current mirror circuit. According to an example, this second current mirror is formed by using P-channel MOS transistors, or P-type MOS transistors, or PMOS transistors. More specifically, the second current mirror comprises two transistors M703 and M704. A first conduction terminal of transistor M703, forming an output terminal of the second current mirror, is coupled, preferably connected, to the second terminal of resistor R701, and a second conduction terminal of transistor M703 is coupled, preferably connected, to the node delivering power supply potential VDD700. A first conduction terminal of transistor M704, forming an input terminal of the second current mirror, is coupled, preferably connected, to the control terminal of transistor M704, and a second conduction terminal of transistor M704 is coupled, preferably connected, to the node delivering power supply potential VDD700.

According to an example, circuit 700 further comprises a switch 1703 and a capacitor C702 arranged within the second current mirror. More particularly, a first conduction terminal of switch 1703 is coupled, preferably connected, to the conduction terminal of transistor M703, and a second conduction terminal of switch 1703 is coupled, preferably connected, to the conduction terminal of transistor M704. A control terminal of switch 1703 (not shown in FIG. 7) is configured to receive the inverse of the clock signal clocking the operation of circuit 700. A first terminal of capacitor C702 is coupled, preferably connected, to the control terminal of the transistor M703, and a second terminal of capacitor C702 is coupled, preferably connected, to the node receiving the reference potential GND700. The second conduction terminal of transistor M704 supplies a current In+1701 having its value corresponding to the output value of function 501. This current is available at the output node of current source S2In701.

FIG. 8 is a curve illustrating a function 801 of the type of the function 311 described in relation with FIG. 3.

According to an embodiment, function 801 is configured to be used to implement a discrete chaotic system.

According to an embodiment, the domain of function 801 corresponds to the domain of the function 501 described in relation with FIG. 5, which has been reduced by from 10 to 30%. In other words, the domain of function 801 is the set of real numbers in the range from zero to one, reduced by from 10 to 30%. These margins can be introduced to overcome practical problems of implementation of the function 501 described in relation with FIG. 5. The set of destination of function 801 then is the set of real numbers in the range from zero to one, zero and one being included in this domain. However, when the output value of function 801 is no longer included in its domain, it is artificially associated with a limiting value of this domain.

According to an embodiment, like function 501, function 801 is obtained by assembly of two affine functions 801A and 801B having negative slopes. According to an embodiment, function 801A has as a domain the set of real numbers in the range from zero to a real number Xth2 reduced by from 10 to 30%, and function 801B has as a domain the set of real numbers in the range from real number Xth2 to one, reduced by from 10 to 30%. Real number Xth2 is called threshold value of function 801.

FIG. 9 is an example of an electronic circuit 900 configured to implement the function 801 described in relation with FIG. 1.

According to an example, electronic circuit 900 is a current implementation of function 801. In other words, the input and output values of function 801 are current values. It would be within the abilities of those skilled in the art to devise a voltage implementation of function 801, that is, an implementation of function 801 where the input and output values are voltage or potential values.

According to an example, circuit 900 comprises four first current sources configured to supply a multiple of a current In901. It is considered that the value of this current In901 represents, at the turning-on of circuit 900, the initial value imposed on function 801. Then, during the subsequent operation of circuit 900, that is, during the implementation of the various iterations of the discrete chaotic system using function 801, current value In901 corresponds to the image value obtained at the output of function 801. In practice, circuit 900 comprises three current sources SIn901-1, SIn901-2, and SIn901-3 configured to supply current In901, a current source S2In901 configured to supply twice current In901. According to an example, sources SIn901 and S2In901 are all powered with a power supply potential VDD900.

According to an example, circuit 900 further comprises seven second current sources SIref901, S2Iref901-1, S2Iref901-2, SIref901-3, SIref901-4, S3Iref901-1, and S3Iref901-2, all configured to supply a multiple of a reference current Iref901. The value of reference current Iref901 represents the threshold values separating the various affine functions, but also the shift thresholds of these affine functions

According to an example, current source SIref901 is configured to be powered by current source SIn901-1, and is coupled, preferably connected, to a node delivering a reference potential GND901. The junction node between current sources SIn901-1 and SIref901 enables to implement a condition Cond901 executing a comparison between a value obtained by function 901 and a threshold value represented by current Iref901.

According to an example, current source S2Iref901-1 is configured to be powered by current source SIn901-2, and is coupled, preferably connected, to the node delivering reference potential GND901. The junction node between current sources SIn901-2 and S2Iref901-1 enables to implement a condition Cond902 executing a comparison between a value obtained by function 901 and a threshold value represented by twice current Iref901.

According to an example, current source S3Iref901-1 is configured to be powered by current source SIn901-3, and is coupled, preferably connected, to the node delivering reference potential GND901. The junction node between current sources SIn901-3 and S3Iref901-1 enables to implement a condition Cond903 executing a comparison between a value obtained by function 901 and a threshold value represented by the triple of current Iref901.

According to an example, circuit 900 further comprises a control circuit 910 (CTRL) configured to receive the result of conditions Cond901, Cond902, and Cond903 and to delivering control potentials.

According to an example, current source S2Iref901-2 is configured to be powered by current source S2In901 via a switch 1901, and is coupled, preferably connected, to the node delivering reference potential GND901. According to an example, switch 1901 is controlled by control circuit 910.

According to an example, current source S2Iref901-2 is configured to be powered by current source S2In901 via a switch 1901, and is coupled, preferably connected, to the node delivering reference potential GND901. According to an example, switch 1901 is controlled by control circuit 910.

According to an example, current source S2Iref901-4 is configured to be powered by current source S2In901 via a switch 1903, and is coupled, preferably connected, to the node delivering reference potential GND901. According to an example, switch 1903 is controlled by control circuit 910.

According to an example, current source S3Iref901-2 is configured to be powered by current source S2In901, and is coupled, preferably connected, to the node delivering reference potential GND901.

According to an example, circuit 900 further comprises a resistor R901 and a first current mirror circuit. According to an example, a first terminal of resistor R901 receives power supply potential VDD900, and a second terminal of resistor R901 is coupled, preferably connected, to an output terminal of the first current mirror circuit.

According to an example, this first current mirror is formed by using NMOS transistors. More particularly, the first current mirror comprises two transistors M901 and M902. A first conduction terminal of transistor M901, forming an output terminal of the first current mirror, is coupled, preferably connected, to the second terminal of resistor R901, and a second conduction terminal of the transistor M901 is coupled, preferably connected, to the node delivering reference potential GND900. A first conduction terminal of transistor M902, forming an input terminal of the first current mirror, is coupled, preferably connected, to the control terminal of transistor M902, and a second conduction terminal of transistor M902 is coupled, preferably connected, to the node delivering reference potential GND900.

According to an example, circuit 900 further comprises a switch 1904 and a capacitor C901 arranged within the first current mirror. More particularly, a first conduction terminal of switch 1904 is coupled, preferably connected, to the conduction terminal of transistor M901, and a second conduction terminal of switch 1904 is coupled, preferably connected, to the conduction terminal of transistor M902. A control terminal of switch 1904 (not shown in FIG. 9) is configured to receive a clock signal clocking the operation of circuit 900. A first terminal of capacitor C901 is coupled, preferably connected, to the control terminal of transistor M901, and a second terminal of capacitor C901 is coupled, preferably connected, to the node receiving reference potential GND900.

According to an example, circuit 900 further comprises a second current mirror circuit. According to an example, this second current mirror is formed by using PMOS transistors. More particularly, the second current mirror comprises two transistors M903 and M904. A first conduction terminal of transistor M903, forming an output terminal of the second current mirror, is coupled, preferably connected, to the second terminal of resistor R901, and a second conduction terminal of transistor M903 is coupled, preferably connected, to the node delivering power supply potential VDD900. A first conduction terminal of transistor M904, forming an input terminal of the second current mirror, is coupled, preferably connected, to the control terminal of transistor M904, and a second conduction terminal of transistor M904 is coupled, preferably connected, to the node delivering power supply potential VDD900.

According to an example, circuit 900 further comprises a switch 1905 and a capacitor C902 arranged within the second current mirror. More particularly, a first conduction terminal of switch 1905 is coupled, preferably connected, to the conduction terminal of transistor M903, and a second conduction terminal of switch 1905 is coupled, preferably connected, to the conduction terminal of transistor M904. A control terminal of switch 1905 (not shown in FIG. 9) is configured to receive the inverse of the clock signal clocking the operation of circuit 900. A first terminal of capacitor C902 is coupled, preferably connected, to the control terminal of transistor M903, and a second terminal of capacitor C902 is coupled, preferably connected, to the node receiving reference potential GND900. The second conduction terminal of transistor M904 supplies a current In+1901 having a value corresponding to the output value of function 801. This current is available at the output node of current source S2In901.

Various embodiments and variants have been described. Those skilled in the art will understand that certain features of these various embodiments and variants may be combined, and other variants will occur to those skilled in the art.

Finally, the practical implementation of the described embodiments and variants is within the abilities of those skilled in the art based on the functional indications given hereabove.

1. A random number generation method, comprising:
implementing a discrete chaotic system which uses an implementation comprising a first function made up of an integer number n of second affine functions which, for an input value in the range from zero to one, zero and one inclusive, provide an output value in the range from zero and one, zero and one inclusive.

2. The method according to claim 1, wherein said discrete chaotic system uses a comparison of a value with at least one threshold.

3. The method according to claim 1, wherein integer n is even.

4. The method according to claim 1, wherein integer n is a power of two.

5. The method according to claim 1, wherein said second affine functions all have a negative slope.

6. The method according to claim 5, wherein said discrete chaotic system is implemented by an electronic circuit in which said input and output values are provided by electric currents.

7. The method according to claim 1, wherein said second affine functions all have a positive slope.

8. The method according to claim 7, wherein said discrete chaotic system is implemented by an electronic circuit in which said input and output values are provided by electric currents.

9. The method according to claim 1, wherein said second affine functions include a first function part with negative slope affine functions and a second function part with positive slope affine functions.

10. The method according to claim 9, wherein said discrete chaotic system is implemented by an electronic circuit in which said input and output values are provided by electric currents.

11. The method according to claim 1, wherein said input value is comprised in a first set included in a second set being the set of real values in the range from zero to one, this first set being reduced by from 10 to 30% of the values with respect to the second set, said second value being comprised in this first set.

12. An authentication method using the method according to claim 1.

13. An electronic device configured to implement the method according to claim 1.

14. A random number generator, comprising:
a circuit implementing a discrete chaotic system which uses an implementation comprising a first function made up of an integer number n of second affine functions which, for an input value in the range from zero to one, zero and one inclusive, provide an output value in the range from zero to one, zero and one inclusive.

15. The generator according to claim 14, wherein said discrete chaotic system further uses a comparison of a value with at least one threshold.

16. The generator according to claim 14, wherein integer n is even.

17. The generator according to claim 14, wherein integer n is a power of two.

18. The generator according to claim 14, wherein said second affine functions all have a negative slope.

19. The generator according to claim 18, wherein said discrete chaotic system is implemented by an electronic circuit in which said input and output values are provided by electric currents.

20. The generator according to claim 14, wherein said second affine functions all have a positive slope.

21. The generator according to claim 20, wherein said discrete chaotic system is implemented by an electronic circuit in which said input and output values are provided by electric currents.

22. The generator according to claim 14, wherein said second affine functions include a first function part with negative slope affine functions and a second function part with positive slope affine functions.

23. The generator according to claim 22, wherein said discrete chaotic system is implemented by an electronic circuit in which said input and output values are provided by electric currents.

24. The generator according to claim 14, wherein said input value is comprised in a first set included in a second set being the set of real values in the range from zero to one, this first set being reduced by from 10 to 30% of the values with respect to the second set, said second value being comprised in this first set.

25. An electronic device comprising the random number generator according to claim 14.

26. A method for random number generation, comprising the following steps:
a) receiving a first value;
b) comparing the received first value to a threshold value;
c1) where comparing in step b) shows that the received first value is less than the threshold value, applying a first affine function to the received first value to generate a second value;
c2) where comparing in step b) shows that the received first value is greater than the threshold value, applying a second affine function, different from the first affine function, to the received first value to generate the second value; and
d) applying the generated second value as the first value in step a).
